(19) United States
(12) Patent Application Publication
(10) Pub. No.: US 2026/0046290 A1
(43) Pub. Date: Feb. 12, 2026

(54) INFORMATION PROCESSING SYSTEM, NON-TRANSITORY COMPUTER-READABLE STORAGE MEDIUM, AND METHOD

(71) Applicant: NINTENDO CO., LTD., Kyoto-shi (JP)

(72) Inventors: Fumihiko TAMIYA, Kyoto-shi (JP); Kimitaka INABA, Kyoto-shi (JP); Chie EBIHARA, Kyoto-shi (JP); Emiko YOMODA, Kyoto-shi (JP)

(21) Appl. No.: 19/289,529

(22) Filed: Aug. 4, 2025

(30) Foreign Application Priority Data
Aug. 9, 2024 (JP) 2024-134353

(51) Int. Cl. H04L 9/40

(52) U.S. Cl. CPC H04L 63/102

(57) ABSTRACT

An approver setting unit configured to set an approver account for a certain account, a friend setting unit configured to set friend relation under which a predetermined feature is available, an approval request unit from a first account for setting a second account among accounts set in friend relation with the first account, as a communication-permitted friend for the first account, a communication-permitted friend setting unit configured to set the second account as the communication-permitted friend for the first account, and a communication execution unit configured to allow communication with an account which is the communication-permitted friend are included.

This non-provisional application is based on Japanese Patent Application No. 2024-134353 filed with the Japan Patent Office on Aug. 9, 2024, the entire contents of which are hereby incorporated by reference.

### FIELD

The present disclosure relates to a system, a non-transitory computer-readable storage medium, and a method.

### BACKGROUND AND SUMMARY

It has been known that, in a game system, approval by a supervisor is required as a condition for setting friend relation between accounts. The accounts that are friends with each other can be provided with various services.

Requirement for approval to become a friend may make smooth construction of friend relation difficult. With general use of a communication function using sound or a camera, on the other hand, unrestricted use of various services by everybody may lead to inappropriate use.
(Configuration 1) An exemplary embodiment provides a system that includes an approver setting unit configured to set an approver account for a certain account, a friend setting unit configured to set the certain account and another account in friend relation without an approval by the approver account, under which a predetermined feature is available, in accordance with an application from the certain account to the another account and acceptance by the another account, of the application, a communication-permitted friend setting unit configured to set a second account as a communication-permitted friend for a first account for which the approver account has been set, the second account being an account among accounts set in friend relation with the first account, based on (i) an approval request from the first account for setting the second account as the communication-permitted friend for the first account and (ii) an approval for the approval request by the approver account set for the first account, and a communication execution unit configured to allow a terminal with which the first account has been associated to perform communication accompanied by sound, with a terminal with which an account that is the communication-permitted friend has been associated.
(Configuration 2) In Configuration 1, an information processing system further includes a storage where information on the communication-permitted friend inputted by the approver account is stored in a manner viewable at least by the approver account and not viewable by the first account.
(Configuration 3) In Configuration 2, in the storage, the information associated with the account that is the communication-permitted friend is viewable by the approver account, regardless of change of an icon image or a name of the communication-permitted friend.
(Configuration 4) In Configuration 2, a terminal associated with the approver account is caused to show another account with which the first account is currently performing communication accompanied by the sound, together with the information on the another account inputted by the approver account.
(Configuration 5) In any of Configurations 1 to 4, when an approval request for setting a third account as the communication-permitted friend for the first account is issued again, the third account being an account the approval request of which for setting as the communication-permitted friend for the first account was not permitted by the approver account in a past, a terminal associated with the approver account is caused to show that the approval request of the third account was not approved in the past.
(Configuration 6) In any of Configurations 1 to 4, a camera video image communication unit is further included, the camera video image communication unit being configured to allow, based on (i) a camera use approval request for showing a camera video image at a terminal with which an account of a communication counterpart has been associated, the camera video image being transmitted from the first account for each communication accompanied by the sound, in which the first account participates, and (ii) an approval for the camera use approval request by the approver account set for the first account, display of the camera video image corresponding to the first account at a terminal with which another account has been associated, during communication accompanied by the sound corresponding to the approved camera use approval request.
(Configuration 7) In any of Configurations 1 to 6, a camera video image communication unit is further included, the camera video image communication unit being configured to allow, based on (i) a camera use approval request for showing a camera video image corresponding to another account at a terminal with which the first account has been associated, the camera video image being received by the first account for each communication accompanied by the sound, in which the first account participates, and (ii) approval for the camera use approval request by the approver account set for the first account, display of a camera video image transmitted from a terminal with which the another account has been associated, during communication accompanied by the sound corresponding to the approved camera use approval request.
(Configuration 8) In any of Configurations 1 to 7, a camera video image communication unit is further included, the camera video image communication unit being configured to allow, based on (i) an approval request for showing a camera video image between the first account and the another account for each communication accompanied by the sound, in which the first account participates, and (ii) approval for an approval request for transmission/reception of the camera video image by the approver account set for the first account, display of the camera video image between the terminal with which the first account has been associated and a terminal with which the another account has been associated, during communication accompanied by the sound corresponding to the approved approval request.
(Configuration 9) In any of Configurations 1 to 8, a camera video image communication unit is configured to allow the approver account to set a manner of display of a camera video image at another terminal with which the another account has been associated, the camera video image being transmitted by the terminal with which the first account has been associated in communication accompanied by the sound, in which the terminal associated with the first account participates, the another account participating in the communication.
(Configuration 10) In Configuration 9, the camera video image communication unit is configured to allow the approver account to set a plurality of levels of the manner of display of the camera video image, allowing the first account to select a manner of display of the camera video image at a level equal to or lower than a level set by the approver account, and causing the another terminal to show the camera video image in the selected manner of display.
(Configuration 11) Another exemplary embodiment provides a program configured to be used for management of a first account for which an approver account has been set in a system in which a predetermined feature is available to the first account and another account between which friend relation has been set, a terminal with which the first account has been associated including one or more processors, the program causing the one or more processors to perform transmitting an approval request from the first account for setting a second account as a communication-permitted friend for the first account, the second account being an account among accounts in friend relation with the first account, and performing communication accompanied by sound with a terminal with which an account that is the communication-permitted friend has been associated.
(Configuration 12) Another exemplary embodiment provides a program configured to be used in an information processing system configured to manage a first account for which an approver account has been set in a system in which a predetermined feature including communication accompanied by sound is available to a first account and another account between which friend relation has been set, a terminal with which the approver account has been associated including one or more processors, the program causing the one or more processors to perform receiving an approval request for setting a second account as a communication-permitted friend for the first account, the second account being an account among accounts in friend relation with the first account, and transmitting approval or rejection of the approval request.
(Configuration 13) In Configuration 12, the program causes the one or more processors to perform storing information on the communication-permitted friend inputted by the approver account in a manner viewable at least by the approver account and not viewable by the first account.
(Configuration 14) In Configuration 12 or 13, the program causes the one or more processors to perform approving a camera use approval request for showing a camera video image at a terminal with which an account of a communication counterpart has been associated, the camera video image being transmitted from the first account for each communication accompanied by the sound, in which the first account participates.
(Configuration 15) In any of Configurations 12 to 14, the program causes the one or more processors to perform approving a camera use approval request for showing a camera video image corresponding to another account at a terminal with which the first account has been associated, the camera video image being received by the first account for each communication accompanied by the sound, in which the first account participates.
(Configuration 16) In any of Configurations 12 to 15, the program causes the one or more processors to perform causing the approver account to set a manner of display of the camera video image at another terminal with which another account has been associated, the camera video image being transmitted by a terminal with which the first account has been associated in communication accompanied by the sound, in which the terminal associated with the first account participates, the another account participating in the communication.
(Configuration 17) Another exemplary embodiment provides a method configured to be used for management of a first account for which an approver account has been set in a system in which a predetermined feature is available to the first account and another account between which friend relation has been set. The method includes transmitting an approval request from the first account for setting a second account as a communication-permitted friend for the first account, the second account being an account among accounts in friend relation with the first account, and performing communication accompanied by sound with a terminal with which an account that is the communication-permitted friend has been associated.
(Configuration 18) Another exemplary embodiment provides a method configured to be used in an information processing system configured to manage a first account for which an approver account has been set in a system in which a predetermined feature including communication accompanied by sound is available to a first account and another account between which friend relation has been set. The method includes receiving an approval request for setting a second account as a communication-permitted friend for the first account, the second account being an account among accounts in friend relation with the first account, and transmitting approval or rejection of the approval request.
(Configuration 19) In Configuration 18, the method includes storing information on the communication-permitted friend inputted by the approver account in a manner viewable at least by the approver account and not viewable by the first account, in a terminal with which the approver account has been associated.
(Configuration 20) In Configuration 18 or 19, the method includes causing a

terminal with which the approver account has been associated to approve a camera use approval request for showing a camera video image at a terminal with which an account of a communication counterpart has been associated, the camera video image being transmitted from the first account for each communication accompanied by the sound, in which the first account participates.
(Configuration 21) In any of Configurations 18 to 20, the method includes causing a terminal with which the approver account has been associated to approve a camera use approval request for showing a camera video image corresponding to another account at a terminal with which the first account has been associated, the camera video image being received by the first account for each communication accompanied by the sound, in which the first account participates.
(Configuration 22) In any of Configurations 18 to 21, the method includes causing, in a terminal with which the approver account has been associated, the approver account to set a manner of display of a camera video image at another terminal with which the another account has been associated, the camera video image being transmitted by a terminal with which the first account has been associated in communication accompanied by the sound, in which the terminal associated with the first account participates, the another account participating in the communication.

The foregoing and other objects, features, aspects, and advantages of the present disclosure will become more apparent from the following detailed description of the present disclosure when taken in conjunction with the accompanied by drawings.

### BRIEF DESCRIPTION OF THE DRAWINGS

FIG. 1 shows an exemplary illustrative non-limiting drawing illustrating a schematic diagram showing an exemplary information processing system according to the present embodiment.

FIG. 2 shows an exemplary illustrative non-limiting drawing illustrating an exemplary hardware configuration of a server included in the information processing system according to the present embodiment.

FIG. 3 shows an exemplary illustrative non-limiting drawing illustrating an exemplary hardware configuration of a game terminal included in the information processing system according to the present embodiment.

FIG. 4 shows an exemplary illustrative non-limiting drawing illustrating a schematic diagram showing an exemplary hardware configuration of a terminal included in the information processing system according to the present embodiment.

FIG. 5 shows an exemplary illustrative non-limiting drawing illustrating an exemplary timing chart for illustrating processing for setting friend relation.

FIG. 6 shows an exemplary illustrative non-limiting drawing illustrating an exemplary timing chart for illustrating processing for approval or rejection of a chat-permitted friend.

FIG. 7 shows an exemplary illustrative non-limiting drawing illustrating an exemplary initial screen of a supervision app.

FIG. 8 shows an exemplary illustrative non-limiting drawing illustrating an exemplary screen showing information on the chat-permitted friend of a supervised account.

FIG. 9 shows an exemplary illustrative non-limiting drawing illustrating an exemplary screen showing a list of requests for permission for a chat-permitted friend.

FIG. 10 shows an exemplary illustrative non-limiting drawing illustrating an exemplary screen where whether or not an account B is to be registered as the chat-permitted friend for the supervised account.

FIG. 11 shows an exemplary illustrative non-limiting drawing illustrating an exemplary screen for input of memo information.

FIG. 12 shows an exemplary illustrative non-limiting drawing illustrating an exemplary screen after registration of account B.

FIG. 13 shows an exemplary illustrative non-limiting drawing illustrating an exemplary timing chart for illustrating processing for approving a camera video image.

FIG. 14 shows an exemplary illustrative non-limiting drawing illustrating an exemplary screen in which a result in response to a request for permission for transmission/reception of a camera video image is determined.

FIG. 15 shows an exemplary illustrative non-limiting drawing illustrating an exemplary screen for setting a state of a chat in which transmission/reception of a camera video image has been permitted.

FIG. 16 shows an exemplary illustrative non-limiting drawing illustrating an exemplary screen in which a first mode is selected from among camera video image display modes.

FIG. 17 shows an exemplary illustrative non-limiting drawing illustrating an exemplary screen in which a second mode is selected from among the camera video image display modes.

FIG. 18 shows an exemplary illustrative non-limiting drawing illustrating an exemplary screen in which a third mode is selected from among the camera video image display modes.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### Embodiment

### [A. Overview]

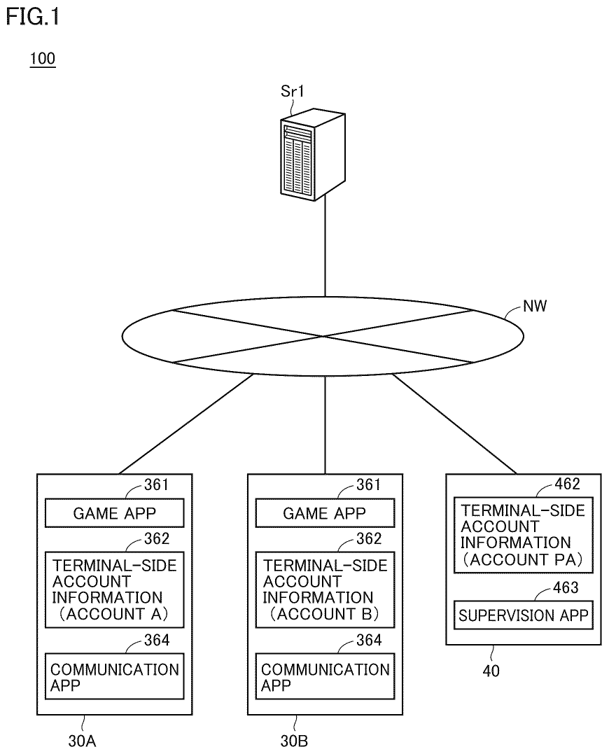

An exemplary configuration of an information processing system 100 according to the present embodiment will be described. Exemplary information processing system 100 according to the present embodiment will be described with reference to FIG. 1. Information processing system 100 is a system configured to provide a service such as management of an account with a server Sr1. The account is information for identification of a user. Information on all generated accounts may be stored in server Sr1.

In information processing system 100 in the present embodiment, a certain account can supervise another account. An account that supervises a specific account is referred to as a “supervisor account” below. The specific account to be supervised by the supervisor account is referred to as a “supervised account.” The supervised account is, for example, an account of a child. The supervisor account is, for example, an account of a parent of the child. In the present embodiment, a supervisor account can view a status of play of a game and a status of purchase of a game by a supervised account and give various types of approval to the supervised account.

A user can register a certain account and another account as the supervisor account and the supervised account in server Sr1, respectively, by performing predetermined processing. An account registered as neither of the supervised account and the supervisor account is referred to as a “general account.”

In information processing system 100 in the present embodiment, a plurality of accounts can communicate with each other with the use of terminals thereof. Though communication includes at least one of communication accompanied by sound and communication by text, communication accompanied by sound will mainly be described in the present embodiment.

Communication is realized by execution of a communication application program 364 stored in each terminal. Communication application program 364 is a program for executing a chat application (which is referred to as a “chat app”). A plurality of accounts that participate in the same communication group (which is referred to as a virtual room below) while the chat app is running can communicate. In the present embodiment, the chat app can allow communication between users while it causes one or more accounts to distribute a game in the virtual room. Communication by using the chat app is simply referred to as a “chat” below. Distribution of a game does not have to be performed.

Communication between a game terminal associated with a certain account that participates in a certain virtual room and one or more other game terminals brought in correspondence with one or more other accounts that participate in the virtual room, respectively, is enabled by satisfaction of a predetermined condition. Server Sr1 may perform at least a part of processing for determining whether or not a predetermined condition in connection with an account is satisfied.

An exemplary predetermined condition in communication between accounts (the general account and the supervisor account) that do not fall under the supervised account is that friend relation has been set therebetween. The friend relation refers to relationship that allows at least one of predetermined features to be provided to two accounts. A method of construction of friend relation is not limited. By way of example, the user may input a friend code or the like of an account with which the user desires to become a friend, to the user's terminal to apply to a specific account for friend relation.

The predetermined feature may be, for example, a function to show information on a friend (an on-line status of a friend, a game title being played by the friend, information indicating details and time and day of becoming a friend, or the like), to transmit an invitation to an on-line game, and to allow play of a game in the same team. So long as each account is in friend relation with at least another account in the virtual room, it does not have to be in friend relation with all other accounts. The friend relation is relation that allows provision of a communication function and does not have to provide other functions.

The supervised account in the present embodiment, on the other hand, is not permitted to perform a chat by using a chat app unless another account is registered as being in a predetermined state for the supervised account, even when friend relation between the supervised account and that another account has been set. In the present embodiment, the predetermined state is called a “chat-permitted friend.” The chat-permitted friend for a certain supervised account is a friend permitted by the supervisor account for the supervised account to communicate, among friends of the supervised account.

The supervised account selects a friend with which the supervised account desires to chat from among his/her friends and issues to the supervisor account, an approval request for registration of the selected account as the chat-permitted friend. The supervisor account determines whether to approve or reject this approval request.

In the present embodiment, in an example where the supervised account itself invites a friend to a chat, the supervised account can invite only the chat-permitted friend to the virtual room. In addition, in the present embodiment, in an example where the supervised account himself/herself is invited to a chat by another account, the supervised account can participate in the virtual room only when all accounts invited to the virtual room are chat-permitted friends. “All accounts invited to the virtual room” in the present embodiment include not only accounts that are participating in the virtual room but also an account that has been invited but has not yet participated or an account that participated but later left the virtual room.

An example in which an account PA associated with a terminal 40 is the supervisor account and an account A associated with a game terminal 30A is the supervised account will be described below. Account PA is, for example, a parent of account A.

### [B. Overall Configuration]

Information processing system 100 may include server Sr1 and a plurality of terminals such as several ten, several hundred, or more terminals. The plurality of terminals may include a dedicated game terminal, a smartphone, a tablet, a PC, and the like. The plurality of terminals and server Sr1 included in information processing system 100 are connectable to one another over a network NW. Network NW is, for example, the Internet. In the example in FIG. 1, among the plurality of terminals included in information processing system 100, game terminals 30A and 30B and terminal 40 are illustrated.

Game terminals 30A and 30B are information processing apparatuses dedicated for a game for providing a game to a user by way of example. Game terminals 30A and 30B are collectively referred to as a “game terminal 30” below. Each of game terminals 30A and 30B includes a game application program 361, terminal-side account information 362, and communication application program 364. Game application program 361 is a program for executing a game application. Game terminal 30 may be a portable game terminal, a stationary game terminal, or a hybrid of the former. Game terminal 30 may be a general-purpose PC, a smartphone, or the like configured to execute a game application program.

Terminal-side account information 362 includes information on an individual account associated with game terminal 30. Accounts A and B are associated with game terminals 30A and 30B, respectively. Therefore, terminal-side account information 362 included in game terminal 30A and terminal-side account information 362 included in game terminal 30B include information on account A and information on account B, respectively. Communication application program 364 is a program for transmission/reception of sound between users in the virtual room.

Terminal 40 is an information processing apparatus such as a smartphone, a tablet, a PC, a smart watch, or the like. Terminal 40 includes terminal-side account information 462 and a supervision application program 463. Account PA is associated with terminal 40, and terminal-side account information 462 of terminal 40 includes information on account PA. A plurality of accounts may be associated with each of game terminal 30 and terminal 40. In other words, terminal-side account information 462 may include information on a plurality of accounts. The same account may be associated with a plurality of terminals. Account PA may be associated also with game terminal 30A in addition to terminal 40.

In the present embodiment, account PA or account A is an account, for example, registered in advance in server Sr1 in order to receive provision or the like of a service on the network. Such an account may be associated with game terminal 30, or separately therefrom, one or more game terminal accounts may be associated with game terminal 30. For example, by association between an account registered in server Sr1 and a game terminal account, the account and game terminal 30 may substantially be associated with each other. By way of example, a game terminal account not associated with the above account may not be permitted to use a chat or may not be permitted to be set as the supervisor account or the supervised account. Setting of a game terminal account separately from the above account is not particularly distinguished below.

### [C. Exemplary Hardware Configuration]

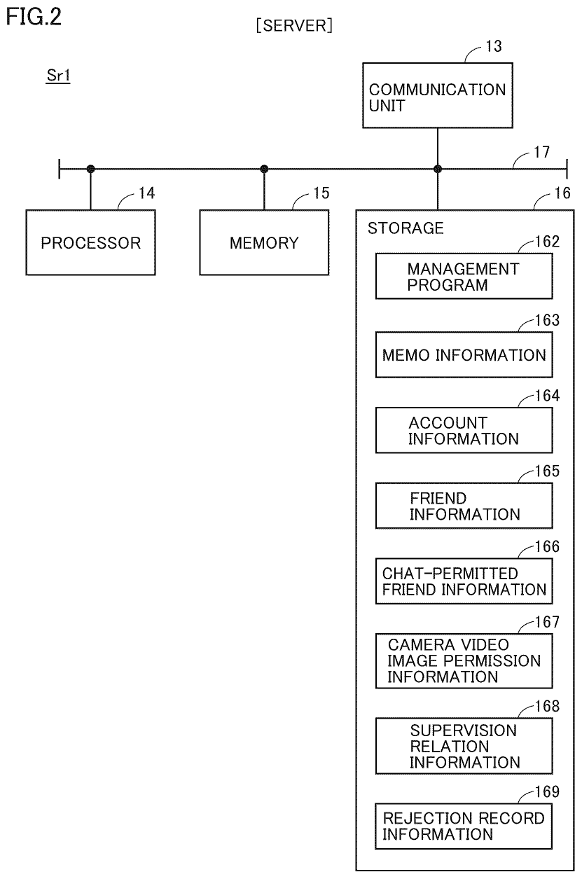

An exemplary hardware configuration of server Sr1, game terminal 30, and terminal 40 included in information processing system 100 according to the present embodiment will be described below with reference to FIGS. 2 to 4.

An exemplary hardware configuration of server Sr1 included in information processing system 100 according to the present embodiment will be described with reference to FIG. 2. Server Sr1 includes one or more processors 14, a memory 15, a storage 16, and a communication unit 13. These components are connected to communicate data with one another through a bus 17. Server Sr1 may be a dedicated information processing apparatus configured to manage an account and to perform communication, or may be implemented by a general-purpose server.

Communication unit 13 communicates with a plurality of terminals included in information processing system 100 over network NW. Communication unit 13 is provided with at least one of hardware necessary for wired communication and hardware necessary for wireless communication. The entirety or a part of processing by communication unit 13 may be performed by processor 14.

Processor 14 is a processing entity for performing processing provided by server Sr1. The term “processor” in the present disclosure means processing circuitry such as a central processing unit (CPU), a micro processing unit (MPU), or a graphics processing unit (GPU). The term “processor” encompasses processing circuitry that performs processing in accordance with instruction codes described in a program, processing circuitry in which a plurality of functions are integrated, such as a system on chip (SoC), hard-wired circuitry, and the like.

Memory 15 is a volatile storage device (storage medium) accessible by processor 14, and for example, a dynamic random access memory (DRAM), a static random access memory (SRAM), or the like may be employed as memory 15. Storage 16 is a non-volatile storage device (storage medium) accessible by processor 14, and for example, a hard disk, a flash memory, or the like may be employed as storage 16. Storage 16 may be, for example, a storage medium attachable to and removable from server Sr1, such as an optical disc and a cartridge.

A management program 162, memo information 163, account information 164, friend information 165, chat-permitted friend information 166, camera video image permission information 167, supervision relation information 168, and rejection record information 169 are stored in storage 16. Processor 14 reads management program 162 and develops and executes the same on memory 15. The term “memory” herein encompasses at least both of a volatile memory and a non-volatile storage.

Management program 162 is a program for centralized control of processing relating to supervision of the supervised account, processing for performing communication, processing for managing an account, and the like. Memo information 163 is memo information on a friend of the supervised account inputted by the supervisor account which will be described later, and it is associated for each supervised account and each friend of the supervised account. A main key for unique identification of memo information 163 may be identification information of the supervised account and identification information of the friend of the supervised account.

Account information 164 is information on all accounts registered in server Sr1, and may include a name, an age, a mail address, a password, and the like of each user. Friend information 165 is information indicating which accounts among all registered accounts are in friend relation. Friend information 165 bidirectionally associates accounts. In an example where friend relation is set between accounts A and B, account A is a friend for account B and account B is also a friend for account A.

Chat-permitted friend information 166 is information indicating which friend among friends of a certain supervised account is a friend for the certain supervised account with which the supervised account is permitted to perform a chat. Unlike friend relation, chat-permitted friend information 166 is unidirectionally stored. Even when account B is registered as the chat-permitted friend for account A, account A is not necessarily registered as the chat-permitted friend for account B. Chat-permitted friend information 166 may include also time and day or the like of becoming the chat-permitted friend.

Camera video image permission information 167 is information indicating whether or not a certain supervised account is permitted to use a camera in certain communication. In the present embodiment, camera video image permission information 167 is generated for each supervised account, for example, each time the supervised account participates in the virtual room.

Supervision relation information 168 is information indicating which accounts of all registered accounts have relationship as the supervisor account and the supervised account. Supervision relation information 168 bidirectionally associates accounts, similarly to friend information 165. Rejection record information 169 is information indicating rejection by the supervisor account, of an approval request for registration of the chat-permitted friend from the supervised account. Rejection record information 169 may include time and day or the like of rejection.

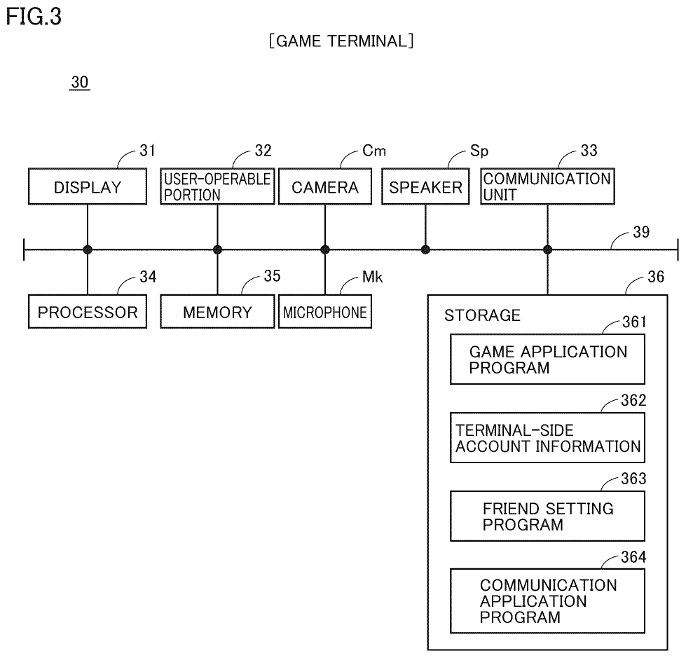

An exemplary hardware configuration of game terminal 30 included in information processing system 100 according to the present embodiment will be described with reference to FIG. 3. Game terminal 30 includes a display 31, a user-operable portion 32, a communication unit 33, one or more processors 34, a memory 35, a storage 36, a camera Cm, a microphone Mk, a speaker Sp, and a bus 39.

Display 31 shows an image generated as a result of information processing performed by processor 34. User-operable portion 32 accepts an operation by the user who operates game terminal 30. User-operable portion 32 may include, for example, at least one of a push button, an operation lever, a touch panel, a mouse, and a keyboard.

Components included in game terminal 30 are connected to communicate data with one another through bus 39. Game terminal 30 realizes communication between accounts through a voice chat, with the use of microphone Mk, camera Cm, and speaker Sp.

Such a component as display 31, user-operable portion 32, microphone Mk, camera Cm, or speaker Sp does not have to be included in game terminal 30. For example, each component may be removable from a main body of game terminal 30. For example, at least one of display 31, user-operable portion 32, microphone Mk, camera Cm, and speaker Sp may be an external apparatus that is different from game terminal 30 and connectable to game terminal 30 through a wire or wirelessly.

A game application program 361, terminal-side account information 362, a friend setting program 363, and communication application program 364 are stored in storage 36.

Game application program 361 may be, for example, downloaded from a not-shown app distribution server over the network to game terminal 30 or read from a separate storage medium. Friend setting program 363 is a program for presenting an application for requesting another account to be in friend relation or for approving a request received from another account.

Communication application program 364 is an application for performing voice communication with a friend. In the present embodiment, communication application program 364 can allow accounts in the virtual room to transmit/receive a camera video image in addition to sound. The camera video image is a video image captured by camera Cm of game terminal 30. In one aspect, supervision application program 463 which will be described later may be stored in storage 36 of game terminal 30.

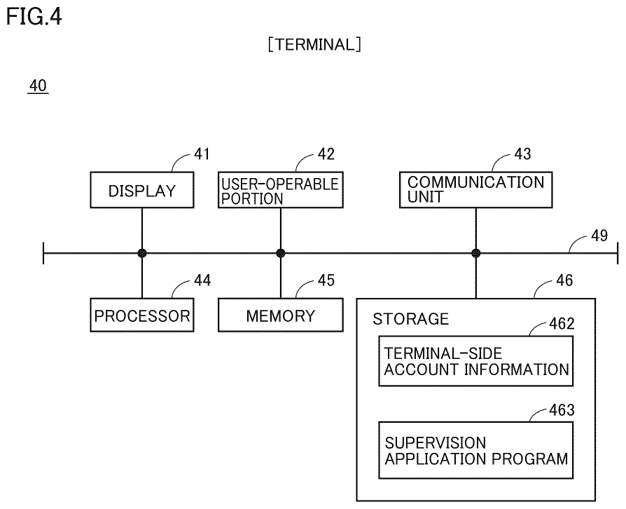

An exemplary hardware configuration of terminal 40 included in information processing system 100 according to the present embodiment will be described with reference to FIG. 4. Terminal 40 includes a display 41, a user-operable portion 42, a communication unit 43, one or more processors 44, a memory 45, a storage 46, and a bus 49.

Display 41 and user-operable portion 42 may be configured, for example, as being integrated as a touch panel. Terminal-side account information 462 and supervision application program 463 are stored in storage 46. Supervision application program 463 is a program for management of a supervised account. Supervision application program 463 can cause display and change of information on the supervised account. In one aspect, communication application program 364 may be stored in storage 46 of terminal 40.

### [D. Chat-Permitted Friend]

As described above, the chat-permitted friend is the friend of the supervised account with which the supervised account is permitted by the supervisor account to perform a chat.

Registration by supervised account A, of account B as the chat-permitted friend will be described below. For issuance by supervised account A, of a request for registration of account B as the chat-permitted friend to supervisor account PA, friend relation should be set between accounts A and B. In the present embodiment, in order for the supervised account to enter friend relation with another account, approval by the supervisor account is not necessary. Based on selection by supervised account A, of account B that has been set as the friend, as the friend with which supervised account A desires to perform a chat, a request for approval for the chat-permitted friend is transmitted to terminal 40 with which supervisor account PA has been associated. The request for approval also includes further causing supervised account A to perform an operation on a button or the like for asking supervisor account PA to give approval. As supervisor account PA approves the request for approval, account B is registered as the chat-permitted friend for supervised account A. In an example where account B is the general account, account A and account B can thus perform a chat by using the chat app.

Account B, on the other hand, may also be the supervised account. For example, account B may be a schoolmate or the like in a real world of account A, and account B may be supervised by an account of a not-shown parent of account B. The chat-permitted friend represents unidirectional relationship. In other words, supervised account B is the chat-permitted friend from a point of view of supervised account A, whereas supervised account A may not be the chat-permitted friend from a point of view of supervised account B. In this case, as supervised account A is registered as the chat-permitted friend for supervised account B also from a side of supervised account B, supervised accounts A and B are allowed to chat with each other.

In the present embodiment, while supervised account A registers supervised account B as the chat-permitted friend and supervised account B does not register supervised account A as the chat-permitted friend, supervised account A can invite supervised account B to the chat. Supervised account A, however, is not the chat-permitted friend for supervised account B. Therefore, since supervised account A which is not the chat-permitted friend is present in the virtual room to which supervised account B has been invited, supervised account B is unable to participate in the virtual room. In thus performing the chat between the supervised accounts, the supervised accounts should register each other as the chat-permitted friends.

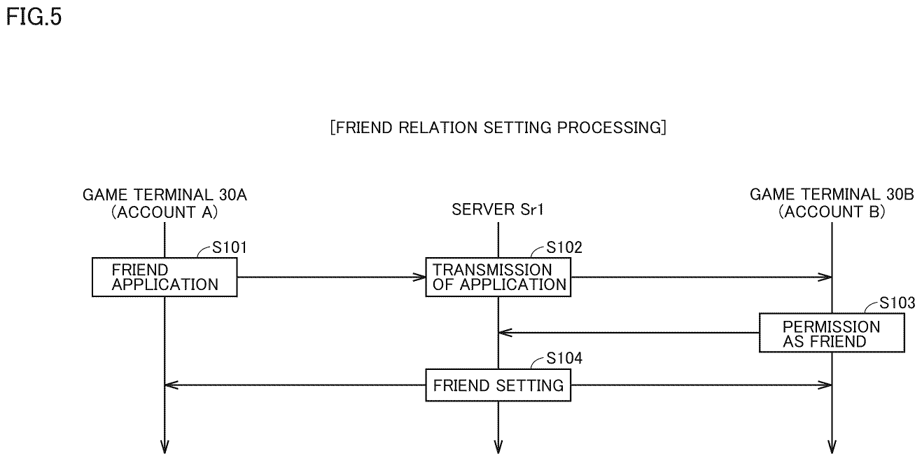

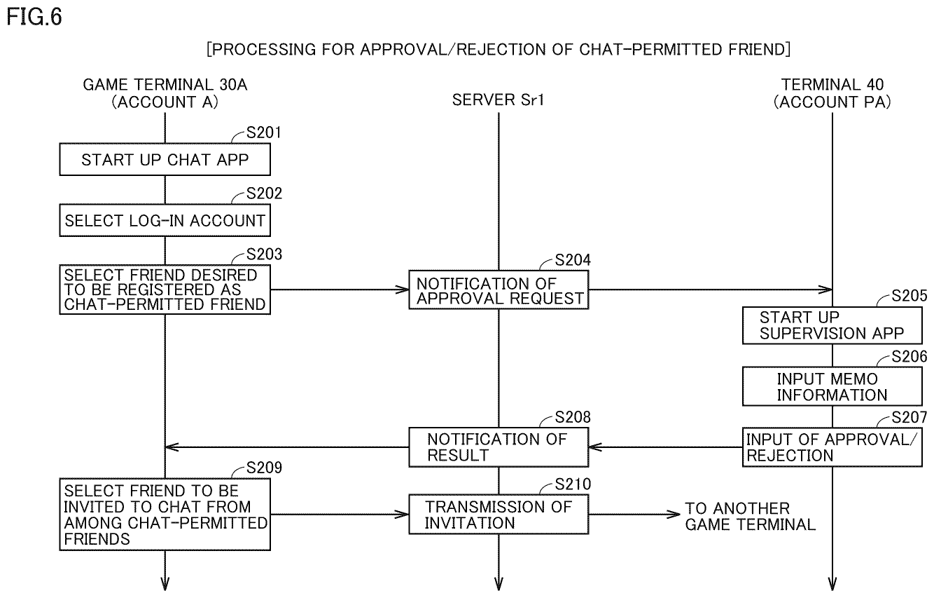

A processing procedure of registration of account B as the chat-permitted friend of supervised account A from a state in which friend relation has not been set between accounts A and B will be described below with reference to FIGS. 5 and 6. At least one of processing in FIG. 5 and processing in FIG. 6 may be performed not only for account B alone but also collectively for a plurality of accounts.

An exemplary timing chart for illustrating processing for setting friend relation will be described with reference to FIG. 5. Game terminal 30A with which account A has been associated executes friend setting program 363 and presents a friend application indicating desire to add account B as the friend to server Sr1 (step S101).

Server Sr1 transmits the friend application from account A to game terminal 30B with which account B has been associated (step S102). Game terminal 30B transmits permission for the friend application to server Sr1 based on an operation by account B (step S103).

Upon receiving permission as the friend, server Sr1 sets friend relation between accounts A and B (step S104). Specifically, server Sr1 adds friend relation between accounts A and B to friend information 165. In step S104, server Sr1 notifies each of game terminals 30A and 30B that friend relation has been set.

An exemplary timing chart for illustrating processing for approval or rejection of the chat-permitted friend will be described with reference to FIG. 6. Game terminal 30A starts up a chat app (step S201). Game terminal 30A accepts selection of an account for log-in to the chat app from the user (step S202). In the example in the present embodiment, the user selects account A. Selection of the log-in account may be accepted at the time of start-up of the game terminal or at another timing.

Game terminal 30A accepts selection of a friend desired to be registered as the chat-permitted friend from the user (step S203). In the example in the present embodiment, account B is selected. In step S203, game terminal 30A issues an approval request for registration of account B as the chat-permitted friend for account A. In step S203, game terminal 30A transmits a result of accepted selection as the approval request to server Sr1.

In the present embodiment, supervisor account PA has been associated with supervised account A. A method of setting supervising-supervised relation between accounts is not limited. By way of example, a user corresponding to a parent uses a predetermined on-line service from a PC, a smartphone, a game terminal, or the like to have server Sr1 create account PA. The user then has server Sr1 create account A as a target of supervision while the user logs in as account PA. Server Sr1 thus sets created account PA and account A in supervising-supervised relation. Account PA and account

A may be generated independently of each other, and after generation, server Sr1 may set them in supervising-supervised relation based on a request from account PA or account A.

Based on reception of the approval request, server Sr1 transmits the approval request to terminal 40 associated with supervisor account PA (step S204). In step S204, when rejection record information 169 includes a record of rejection of an account to which the approval request is directed, server Sr1 transmits presence of the record of rejection to terminal 40. At this time, when there is memo information 163 which will be described later in connection with the rejected account, server Sr1 may transmit also that memo information 163. Terminal 40 may provide a pop-up representation or the like on display 41 based on reception of the approval request. Terminal 40 starts up supervision app 463 (step S205) and terminal 40 with which supervisor account PA has been associated shows the received approval request thereon.

To terminal 40, memo information on account B requested to be registered as the chat-permitted friend may be inputted from supervisor account PA (step S206). Supervisor account PA (a parent by way of example) may not be able to identify who in the real world account B is. Accordingly, by way of example, supervisor account PA can input memo information for identification of account B thereby for subsequent reference. Terminal 40 accepts input from supervisor account PA which indicates information indicating approval or rejection, as a result in response to the approval request in step S204 (step S207). Terminal 40 transmits the memo information in step S206 and information indicating approval or rejection in step S207 to server Sr1. In the example in the present embodiment, registration of account B as the chat-permitted friend is approved by supervisor account PA.

Server Sr1 notifies game terminal 30A of information indicating approval or rejection in step S207 as the result in response to the approval request (step S208). When the result indicates approval in step S208, server Sr1 registers the account selected in step S203 as the chat-permitted friend of account A and stores the received memo information as memo information 163, in association with the registered chat-permitted friend. When the result indicates rejection in step S208, server Sr1 updates rejection record information 169 and stores the memo information as memo information 163, in association with the account selected in step S203. In one aspect, memo information 163 may be stored only in supervision app 463 of terminal 40 or stored in each of server Sr1 and supervision app 463. When registration of a certain friend as the chat-permitted friend is canceled, the memo information of that friend may be erased.

Game terminal 30A accepts selection of a friend to be invited to the chat, from among friends registered as the chat-permitted friends (step S209). In the example in the present embodiment, account B is selected. In step S209, game terminal 30A transmits the friend to be invited to a chat to server Sr1. Server Sr1 transmits an invitation to game terminal 30 with which the chat-permitted friend invited to the chat has been associated (step S210).

### [E. Exemplary Screen of Terminal 40 Relating to Approval for Chat-Permitted Friend]

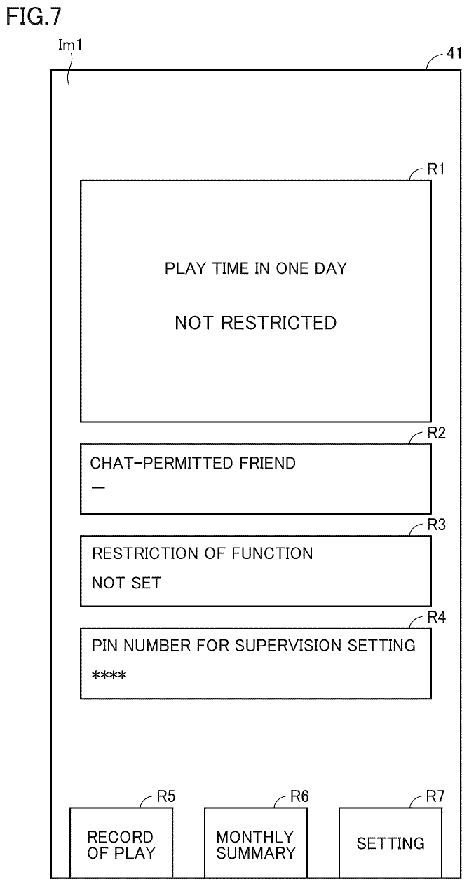

An exemplary display screen on display 41 of terminal 40 in execution of supervision app 463 will be described below with reference to FIGS. 7 to 12. FIGS. 7 to 12 show screens shown on display 41 of terminal 40. An exemplary initial screen Im1 of supervision app 463 will be described with reference to FIG. 7. Initial screen Im1 shows information on a supervised status of supervised account A.

Initial screen Im1 includes regions R1 to R7. Region R1 is a region for setting a time period during which a game app can be played at game terminal 30A in one day. Region R2 is a region for management of the chat-permitted friend of supervised account A. Region R3 is a region for setting restriction of a predetermined function that can be performed at game terminal 30A. Region R4 is a region for setting a pin number necessary for cancellation by an operation on game terminal 30A, of restriction imposed by supervision app 463. For example, the time period during which a game can be played or restriction of the predetermined function that can be performed may be set for each account instead of or in addition to a game terminal.

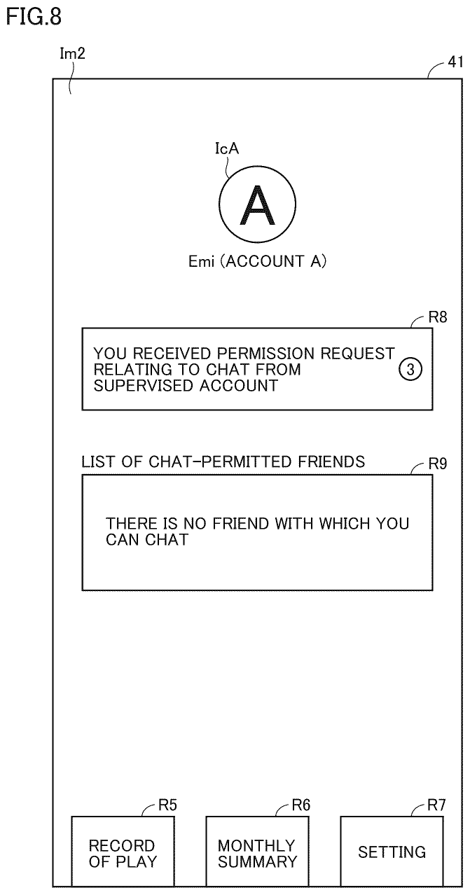

Region R5 is a region for referring to a type or play time of a game app played in the past. Region R6 is a region for referring to a type or play time of a game app played in the past on the monthly basis. Region R7 is a region for making various types of setting of supervision app 463. Upon selection of region R2, the display screen on display 41 makes transition to FIG. 8, for example, via an account selection screen.

An exemplary screen Im2 showing information on the chat-permitted friend of supervised account A will be described with reference to FIG. 8. FIG. 8 shows in an upper part, a name “Emi” of account A and an icon IcA of account A. The name of account A is a name registered in server Sr1 and can be changed. Though FIG. 8 shows characters “(account A)” next to “Emi” for the sake of convenience, only “Emi” may actually be shown. FIG. 8 shows a character “A” as icon IcA for the sake of convenience, an image or the like selected by account A may actually be shown. This is also applicable to figures following FIG. 8.

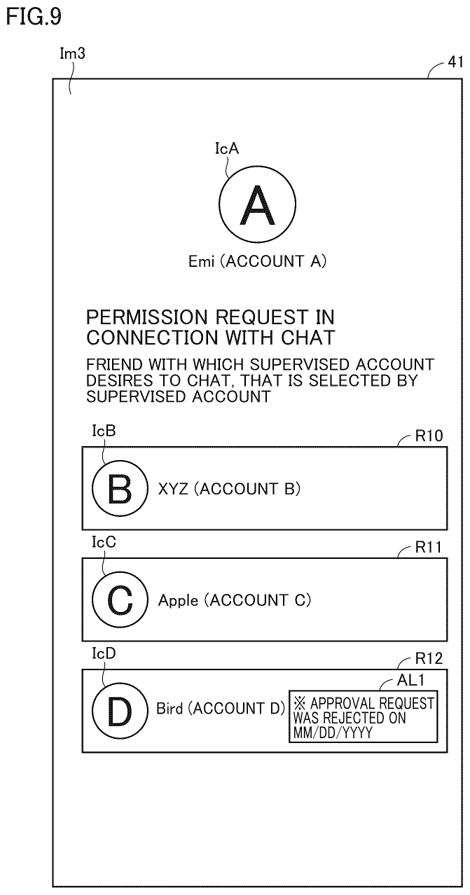

A region R8 is a field of notification of a request to permit the chat-permitted friend by supervised account A. An example in FIG. 8 shows that three permission requests have been issued from supervised account A to supervisor account PA. In region R8, information indicating when at least the latest permission request has been issued may be shown. Though transition to the screen in FIG. 8 by tapping on (selection of) region R2 in FIG. 7 is illustrated by way of example, when there is a request to permit the chat-permitted friend, a pop-up of a system notification of terminal 40 or a pop-up on the display screen shown in FIG. 7 may be shown. At this time, upon tapping on the pop-up, a display screen shown in FIG. 9 may directly be shown. A region R9 is a region where a list of chat-permitted friends is shown. Region R9 shows that no account has been registered as the chat-permitted friend for account A.

Upon selection of region R8, the display screen on display 41 makes transition to FIG. 9. An exemplary screen Im3 showing a list of requests to permit the chat-permitted friend will be described with reference to FIG. 9. Regions R10 to R12 each show an individual permission request, and include icons IcB to IcD of accounts requested to be registered as the chat-permitted friends and names of the accounts. In regions R10 to R12, information indicating when each permission request has been issued may be shown. Upon tapping on the pop-up exemplified above, the display screen shown in FIG. 9 may directly be shown.

Region R10 shows a request for registration of account B. A name of account B is “XYZ”. Region R11 shows a request for registration of an account C. A name of account C is “Apple”. Region R12 shows a request for registration of an account D. A name of account D is “Bird”. Though account B to account D are also shown for the sake of convenience, they do not have to actually be shown.

Region R12 includes an alert AL1. Alert AL1 indicates rejection by supervised account A, of a permission request to set account D as the chat-permitted friend in the past. In the present embodiment, information indicating time and day of rejection is also shown. “Rejection of the permission request” may encompass the fact that an account was once registered as the chat-permitted friend but the registration was canceled. Alert AL1 may show the fact that the permission request was never permitted and the fact that the permission request was once permitted and thereafter canceled, as being distinguished from each other. In one aspect, in region R12, memo information 163 on account D may be shown. Supervisor account PA can determine a result of a present approval request based on determination as to the approval request in the past. Screen Im3 does not have to include alert AL1.

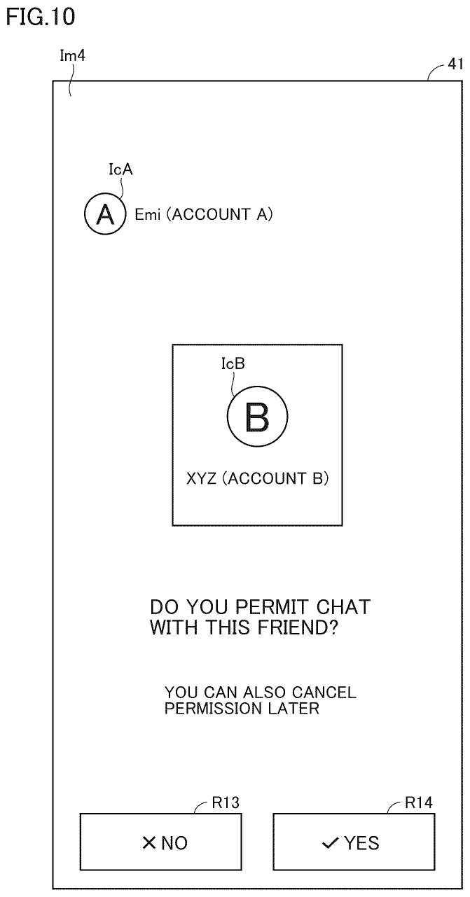

Upon selection of region R10, the display screen on display 41 makes transition to FIG. 10. An exemplary screen Im4 where whether or not to register account B as the chat-permitted friend for account A is determined will be described with reference to FIG. 10.

At the center of screen Im4, icon IcB and the name of account B are shown. A region R13 is a button for rejecting the approval request. A region R14 is a button for approving the approval request. Supervisor account PA selects one of region R13 and region R14. At this time, supervisor account PA can determine whether the approval request should be approved or rejected, for example, by checking directly with supervised account A to find out who account B is. Screen Im4 may include a “back button” for leaving the approval request unprocessed, without selecting the result of the approval request. Screen Im4 may include alert AL1.

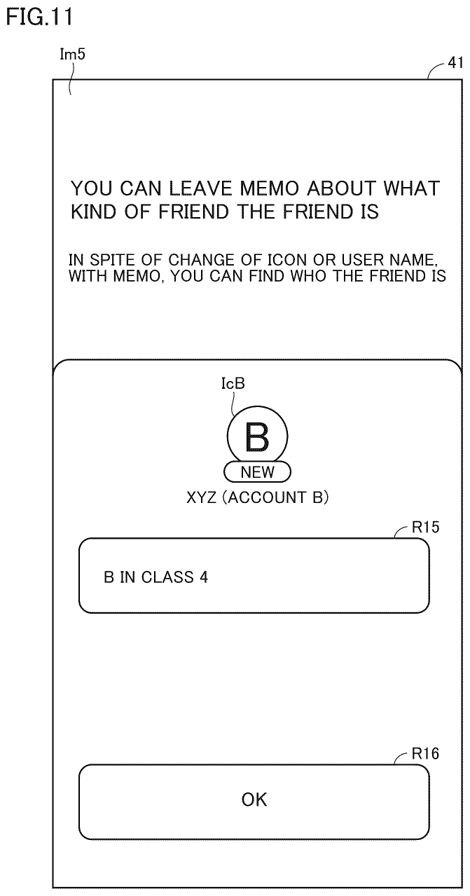

Upon selection of region R14, the display screen on display 41 makes transition to FIG. 11. An exemplary screen Im5 for input of the memo information will be described with reference to FIG. 11. A region R15 is an input field for the memo information. A region R16 is a button for entering the memo information. Supervisor account PA inputs the memo information for identification of account B in region R15. At this time, for example, a parent corresponding to supervisor account PA directly talks with a child corresponding to supervised account A in the real world to directly find out who account B is and to determine whether or not the supervised account and account B are on terms good enough to perform a chat therebetween. Supervisor account PA inputs text information “B in class 4,” for example, as information for identification of account B. Thus, in the present embodiment, in approval for the request to approve the chat-permitted friend, a screen for input of the memo information is shown. Timing to show the screen for input of the memo information is not limited. Input of the memo information may be required or optional. Transition to the screen for input of the memo information may be made also when region R13 is selected in screen Im4. In another embodiment, input of the memo information may not be allowed.

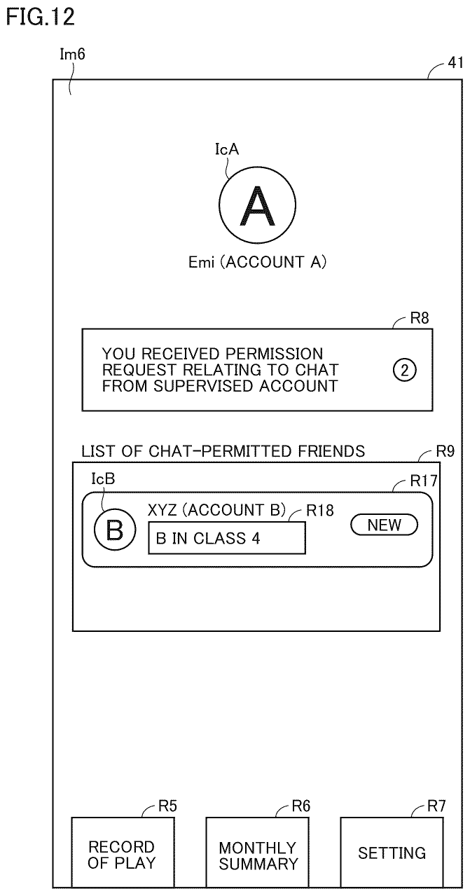

In the present embodiment, supervisor account PA is able to view the inputted memo information, whereas supervised account A is unable to view the same. By way of example, the memo information is shown only at the terminal with which supervisor account PA has been associated and not shown at the terminal with which supervised account A has been associated. Contents in memo information 163 being known to supervised account A can thus be suppressed. Upon selection of region R16, the display screen on display 41 makes transition to FIG. 12. An exemplary screen Im6 after registration of account B will be described with reference to FIG. 12. Though screen Im6 is the same page as screen Im2, it is partially different from screen Im2 as a result of registration of account B.

As a result of processing of one permission request, there are two unprocessed permission requests in region R8 in screen Im6. Region R9 includes a region R17 where account B registered as the chat-permitted friend is shown. Region R17 includes icon IcB, the name of account B, and a region R18 where memo information 163 associated with account B is shown. In region R18, text information “B in class 4” is shown. In one aspect, a button for simultaneously and collectively approving a plurality of permission requests may be provided. In this case, after collective approval, memo information 163 may be inputted for each account.

Supervisor account PA can thus confirm registration of account B as the chat-permitted friend by viewing region R17. Even after lapse of a period since registration, by checking contents in region R18, supervisor account PA more readily knows whose account B actually is, that is named “XYZ” labeled with icon IcB.

More specifically, even when supervisor account PA is unable to guess an actual person from the icon and the name of the account, supervisor account PA can know who account B is, based on the contents in region R18. In the present embodiment, even when the icon and the name of the account are changed after a time point of registration, memo information 163 on account B, which is “B in class 4,” is kept stored in server Sr1. Supervisor account PA can thus readily know who account B is, based on the contents in region R18 in spite of change of the icon and the name of the account.

In information processing system 100 in the present embodiment, supervisor account PA thus determines whether or not the friend of supervised account A is appropriate for performing a chat. An inappropriate chat performed by supervised account A with an account not acknowledged by supervisor account PA can thus be suppressed. As described above, since registration as the chat-permitted friend, only of the account that is the friend, can be requested, erroneous registration of an inappropriate account as the chat-permitted friend can be suppressed.

The chat-permitted friend in the present embodiment is determined for each friend of supervised account A. Once a specific account is registered as the chat-permitted friend, supervised account A does not have to issue again a request for registration of the specific account as the chat-permitted friend. In the present embodiment, on the other hand, approval for transmission/reception of a camera video image which will be described below is required for each chat.

### [F. Transmission/Reception of Camera Video Image]

As described above, with the chat app, while a game video image is distributed, a camera video image in addition to sound can also be transmitted/received. The camera video image is a video image captured by camera Cm. In the present embodiment, the camera video image is assumed to include at least the face of the user. Depending on a direction of image capture by camera Cm or a position of the user, the face of the user may not be included. The chat in the present embodiment is thus what is called a video chat in which not only sound but also a facial expression can be shared.

The camera video image includes both of a video image transmitted from a certain game terminal 30 to another game terminal 30 and a video image received from another game terminal 30 by certain game terminal 30. Game terminal 30 transmits the video image captured by camera Cm to server Sr1 by executing communication application program 364. Server Sr1 transmits the video image received from a certain game terminal 30 to another game terminal 30 by executing management program 162. Furthermore, game terminal 30 can receive the video image from another game terminal 30 via server Sr1 and show the video image in display 31 by executing communication application program 364. Thus, in the present embodiment, communication of the camera video image is performed by execution of management program 162 by server Sr1 and execution of communication application program 364 by game terminal 30. Supervised account A in the present embodiment should separately obtain approval by supervisor account PA for start of transmission/reception of a camera video image in a certain chat.

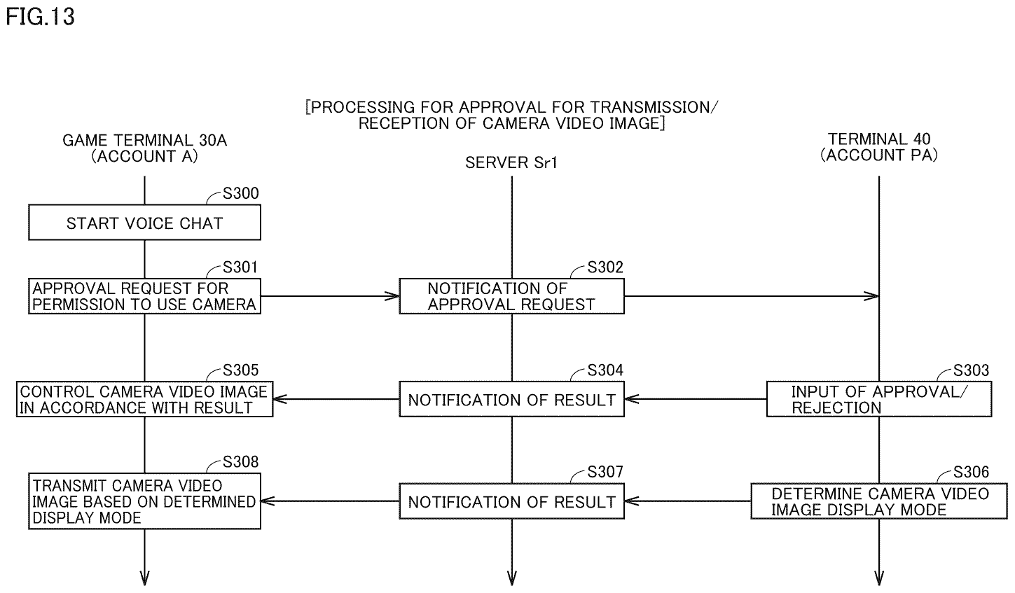

Approval for transmission/reception of the camera video image is required for each chat, unlike approval for the chat-permitted friend. Approval for transmission/reception of the camera video image is required, for example, each time the virtual room is generated. An exemplary timing chart for illustrating processing for approving the camera video image will be described with reference to FIG. 13. After game terminal 30A starts up a chat app, it participates in the virtual room

and starts a chat accompanied by sound (step S300). Game terminal 30A issues an approval request for permission to use the camera in the virtual room in which game terminal 30A is currently participating, based on an operation by supervised account A (step S301). Server Sr1 notifies terminal 40 of the approval request (step S302). Terminal 40 accepts input of approval or rejection of the request to approve camera use permission from supervisor account PA (step S303). Server Sr1 notifies game terminal 30A of a result of input of approval or rejection in step S303 (step S304).

Game terminal 30A controls transmission/reception of the camera video image based on the result of input of approval or rejection in step S303 (step S305). Upon approval in step S303, game terminal 30A transmits/receives the camera video image in step S305.

Upon approval in step S303, terminal 40 can determine a camera video image display mode (step S306). The camera video image display mode indicates a manner of display at least at another game terminal 30, of the camera video image transmitted from game terminal 30A. In the present embodiment, the display mode is categorized into levels. As the level of the display mode is high, a ratio of a range shown at another game terminal 30 in the entire range of the image captured by camera Cm becomes high. Details of the manner of display will be described later.

Server Sr1 gives a notification of a result of the manner of display determined in step S306 (step S307). Game terminal 30A transmits the camera video image based on the display mode determined by supervisor account PA (step S308).

Upon rejection in step S303, in step S305, game terminal 30A does not transmit/receive the camera video image. When rejection is indicated in step S303, processing in steps S306 to 308 is not performed.

When game terminal 30A participates in a new virtual room, in spite of approval once of transmission/reception of the camera video image, it should obtain again approval for transmission/reception of the camera video image. Depending on timing, the supervisor account may not desire transmission/reception of the camera video image even with the same chat counterpart. Unintended transmission/reception of the camera video image can be suppressed.

In the present embodiment, supervisor account PA is caused to collectively approve transmission and reception of the camera video image. Thus, as compared with an example where transmission and reception of the camera video image are individually approved, convenience of supervised account A and supervisor account PA is improved. In one aspect, transmission and reception of the camera video image may individually be approved. In this case, in information processing system 100, the timing chart shown in FIG. 13 may be executed for each of transmission and reception. Supervisor account PA may approve at least one of reception and transmission and may reject the other. Alternatively, in one aspect, approval for only one of transmission and reception of the camera video image may be required, whereas approval for the other may not be required. Alternatively, once the other is approved, approval for the other may thereafter not be required.

In an example where a plurality of supervised accounts participate in the virtual room, when a certain supervised account is permitted to transmit/receive the camera video image but another supervised account is not permitted to transmit/receive the camera video image, the camera video image is not transmitted/received at least between those supervised accounts.

[G. Exemplary Screen of Terminal 40 in Connection with Approval for Camera Video Image]

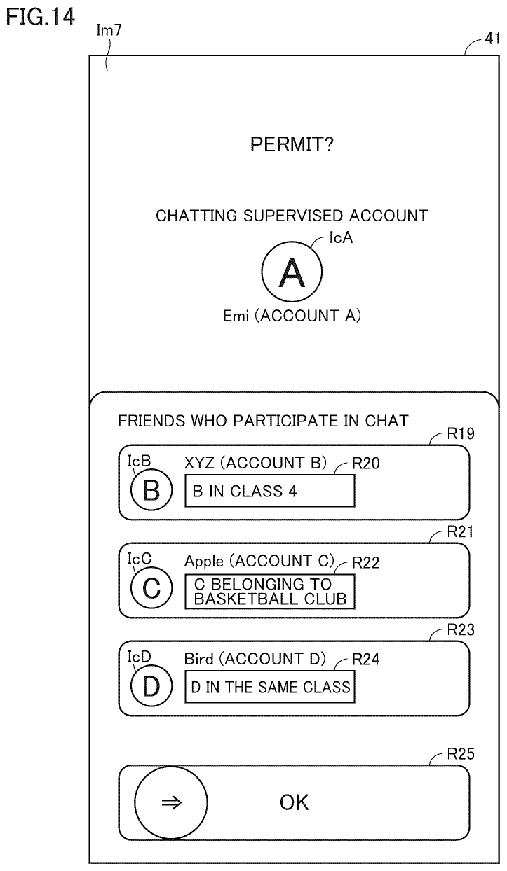

An exemplary display screen on display 41 of terminal 40 in execution of supervision app 463 will be described below with reference to FIGS. 14 to 18. FIGS. 14 to 18 show examples in which accounts C and D in addition to account B are registered as the chat-permitted friends for supervised account A and thereafter a chat is being performed among accounts A to D.

An exemplary screen Im7 where a result in response to the permission request for transmission/reception of the camera video image will be described with reference to FIG. 14. Screen Im7 may be shown on display 41 based on start-up of supervision app 463, upon reception of the notification in above-described step S302 by supervisor account PA.

In screen Im7, accounts B to D with which supervised account A is currently performing a chat are shown. Regions R19, R21, and R23 show information on accounts B, C, and D, respectively. Regions R20, R22, and R24 show memo information 163 associated with accounts B, C, and D, respectively. Supervisor account PA can know with whom supervised account A is chatting, by checking screen Im7. Instead of “accounts who participate in chat,” supervised account A may also be shown in a similar region as a “member in chat,” as being aligned with regions R19, R21, and R23.

When a lock in a region R25 is unlocked, supervised account A is permitted to transmit/receive the camera video image. Instead of region R25, for example, a permission button and a non-permission button may be shown.

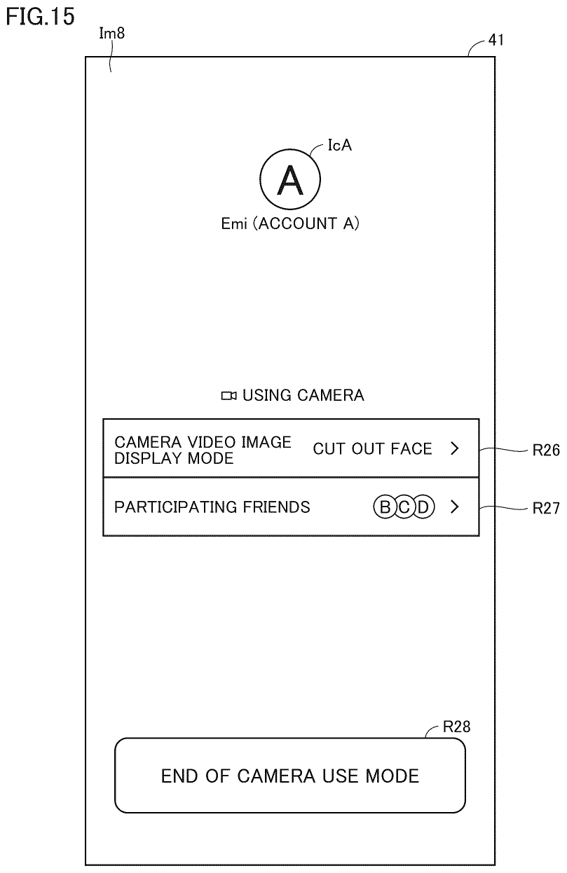

An exemplary screen Im8 for setting a state of the chat in which transmission/reception of the camera video image has been permitted will be described with reference to FIG. 15. Based on acceptance of an instruction to set the state of the chat from supervisor account PA, supervision app 463 has screen Im8 shown on display 41.

In screen Im8, a region R26 is a region for setting the camera video image display mode. A region R27 is a region for showing detailed information on the friends who participate in the chat. A region R28 is a button for stopping transmission/reception of the camera video image. As region R28 is selected, supervisor account PA can stop transmission/reception of the camera video image by supervised account A.

As shown in region R26, by default, a first mode in which the camera video image is shown at another game terminal in such a manner of display that the face of the user of supervised account A has been cut out is set. In other words, the shown camera video image may include no or substantially no body below the face of the user or no or substantially no background such as a room. The “cut-out face” may be a video image extracted along the contour of the face or a video image that is obtained by extracting a predetermined shape such as a circle including the face in a most part. The first mode is a mode lowest in level. The image showing only the face of the user of supervised account A may be generated by recognition and cut-out of the face of the user of supervised account A shown in the image captured by camera Cm.

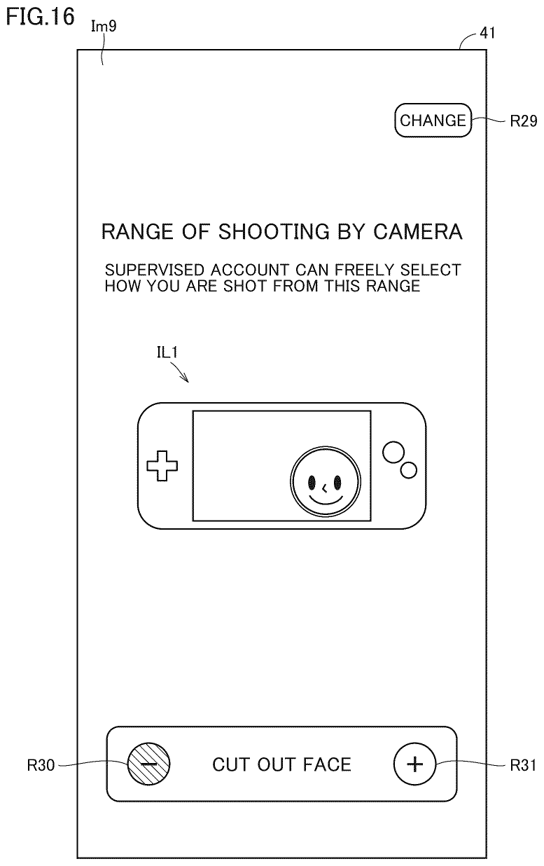

Upon selection of region R26, the display screen on display 41 makes transition to FIG. 16. FIGS. 16 to 18 illustrate switching of the camera video image display mode. An exemplary screen Im9 for selection of the first mode among the camera video image display modes will be described with reference to FIG. 16. Screen Im9 includes regions R29 to R31 and an image IL1. Region R29 is a button for changing the display mode to a mode currently shown on display 41.

Region R30 is a button for lowering the level of the display mode shown on display 41. Since the first mode is the mode lowest in level, it is unselectable in the example in FIG. 16. Region R31 is a button for raising the level of the display mode shown on display 41.

Image IL1 is a conceptual image showing how a transmitted camera video image is shown at another game terminal 30. As shown in image IL1, the face of the user of supervised account A is superimposed on a game image on display 31.

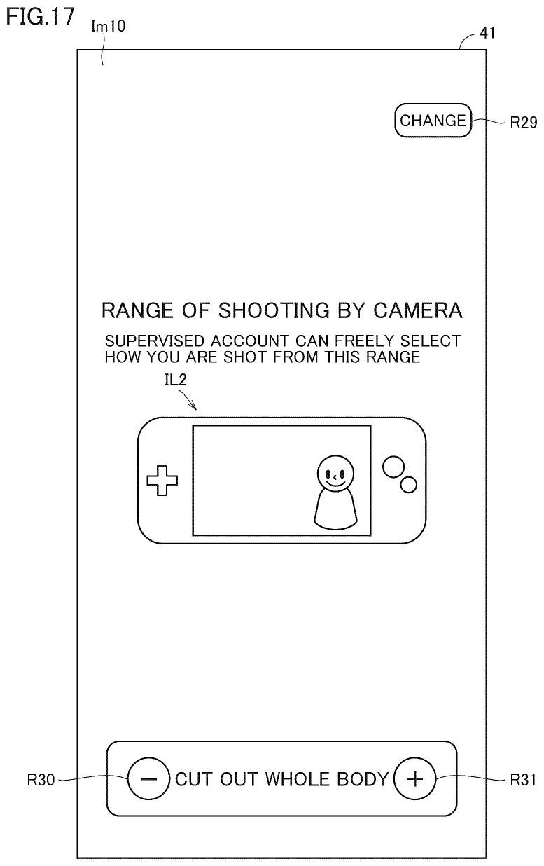

Upon selection of region R31 in FIG. 16, the display screen on display 41 makes transition to FIG. 17. An exemplary screen Im10 for selection of a second mode among the camera video image display modes will be described with reference to FIG. 17. The second mode is a mode in which an image of the cut-out body of the user of supervised account A is shown at game terminals 30 with which accounts B, C, and D have been associated. In other words, the shown camera video image may include no or substantially no background such as a room. For example, the body of the user below the hip does not have to be shown or the whole body may be shown. As shown in an image IL2 included in screen Im10, the face and the body of the user of supervised account A are superimposed on the game image on display 31.

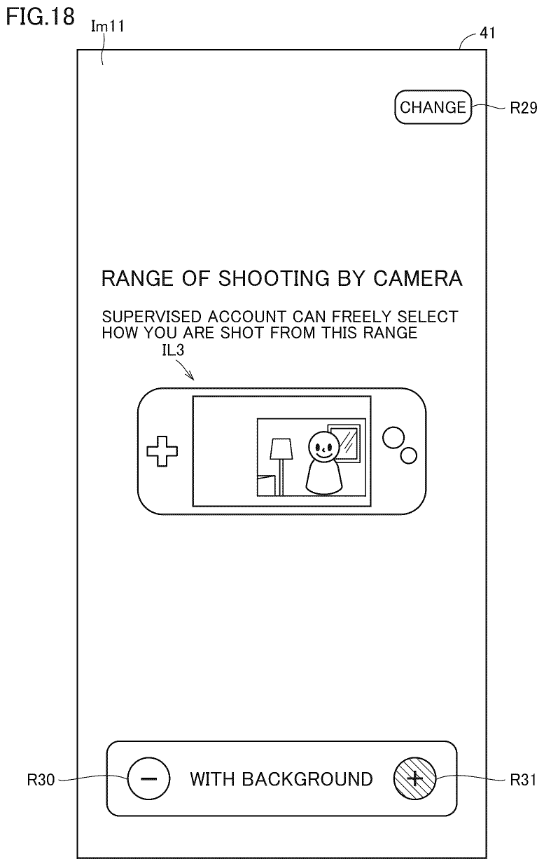

Upon selection of region R29 in FIG. 17, the display mode is changed to the second mode. Upon selection of region R30 in FIG. 17, the display screen on display 41 returns to FIG. 16. Upon selection of region R31 in FIG. 17, the display screen on display 41 makes transition to FIG. 18.

An exemplary screen Im11 for selection of a third mode among the camera video image display modes will be described with reference to FIG. 18. The third mode is a mode in which an image including the body of the user of account A and the background is shown at game terminals 30 with which accounts B, C, and D have been associated. Since the third mode is a mode highest in level, region R31 is unselectable. Upon selection of region R29 in FIG. 18, the display mode is changed to the third mode. Upon selection of region R30 in FIG. 18, the display screen on display 41 returns to FIG. 17. As shown in an image IL3, an image that is captured by camera Cm and includes the background such as the room is superimposed on the game image on display 31. Supervisor account PA can determine the camera video image display mode of supervised account A by selecting region R29 while a desired mode is shown on display 41.

After supervisor account PA determines the display mode, supervised account A can change the display mode within a predetermined range by using game terminal 30A. The predetermined range should only be a range not higher than the display mode determined by supervisor account PA. For example, in an example where supervisor account PA has selected the second mode, supervised account A can select on his/her own will, the first mode or the second mode in the chat that is being performed. Even when supervisor account PA has once selected the display mode, supervised account A may be able to issue a request for changing the selected display mode.

Thus, in the present embodiment, necessity for supervised account A to obtain approval from supervisor account PA in both of registration of the chat-permitted friend and transmission/reception of the camera video image has been described. In one aspect, information processing system 100 requires approval in registration of the chat-permitted friend, however, it does not require approval in transmission/reception of the camera video image.

Similarly, in one further aspect, information processing system 100 may require no approval in registration of the chat-permitted friend but require approval in transmission/reception of the camera video image. In this case, information processing system 100 does not have to have the chat-permitted friend itself, but supervised account A may be able to perform a chat by using communication application program 364 similarly to the general account.

### [H. Modification]

Other forms which are partial modification of the embodiment described above will be described below.

Each of processors 14, 34, and 44 may be implemented by a single chip or a plurality of chips. Each of processors 14, 34, and 44 and associated processing circuitry may be implemented by a plurality of computers connected to one another through a wire or wirelessly over a local area network, a wireless network, or the like. The processor and the associated processing circuitry may be implemented by such a cloud computer as performing remote computation based on input data and outputting a result of computation to another device located at a distant location.

In the example in FIG. 1, server Sr1, game terminal 30, and terminal 40 are each shown as a single apparatus. Each of server Sr1, game terminal 30, and terminal 40, however, may be implemented as an assembly of a plurality of apparatuses. For example, server Sr1 may include a plurality of servers. For example, game terminal 30 and terminal 40 may each include a separate configuration including a main body portion including at least a processor, a terminal portion including at least a user-operable portion, and a display portion including at least a display.

Though memo information 163, account information 164, friend information 165, chat-permitted friend information 166, camera video image permission information 167, supervision relation information 168, and rejection record information 169 are described as being stored in storage 16 of server Sr1 with reference to FIG. 2, at least some of such information may be held by an external server other than server Sr1.

Supervisor account PA is described as a parent of supervised account A in the example above. Actual relationship between supervisor account PA and supervised account A, however, does not have to be parent-child relation or protector-protected relation, and both of accounts may be adults.

Terminal 40 is described as a smartphone or the like in the example above. In one aspect, terminal 40 may be an information processing apparatus dedicated for a game for providing a game, similarly to game terminal 30. In this case, terminal 40 and game terminal 30A may be different apparatuses or identical apparatuses. With reference to the example in the present embodiment, supervisor account PA and supervised account A may be associated with game terminal 30A, and game terminal 30A may be shared.

Though an example in which supervisor account PA supervises supervised account A is described above, a plurality of supervisor accounts may supervise a single supervised account A. In this case, each of the plurality of supervisor accounts may be able to approve one approval request, or all supervisor accounts may be required to approve one approval request. Memo information 163 inputted by a certain supervisor account may be or may not be shared with another supervisor account.

Similarly, a plurality of supervised accounts may be supervised by a single supervisor account PA. Supervisor account PA can give approval for a chat-permitted friend, approval for transmission/reception of a camera video image, or the like for each of the plurality of supervised accounts.

In the example described above, memo information 163 is text information inputted by supervisor account PA. In one aspect, memo information 163 may be a label prepared in advance by information processing system 100. The label may be, for example, “friend”, “relative”, “neighbor”, or the like. Since supervisor account PA can select memo information 163 based on the label, operability improves. Supervisor account PA itself may be able to create this label.

In the example described above, supervised account A is described as being able to transmit an approval request for a chat-permitted friend and transmission/reception of a camera video image from game terminal 30A via server Sr1 to terminal 40. In one aspect, processing for transmitting the approval request does not have to be incorporated as a function of information processing system 100. In this case, for example, supervised account A directly talks with supervisor account PA, so that supervisor account PA may voluntarily perform approval processing at a terminal thereof.

An example in which supervisor account PA can give approval is described above. The supervisor account is an exemplary “approver account” in the present disclosure. In one aspect, supervisor account PA may temporarily give the authority to give approval, for example, to another account that supervisor account PA can trust. In this case, the account temporarily given the authority also corresponds to an exemplary “approver account.” Alternatively, in one aspect, the supervisor account may have no authority to give approval but may simply be permitted to view play time or the like of the supervised account. At this time, another account may have the authority to give approval. In this case, that another account corresponds to an exemplary “approver account.” Alternatively, in one aspect, an approver account and an approved account may be set separately from the supervisor account and the supervised account.

In the example described above, a camera video image of the supervised account permitted to transmit/receive the camera video image can be shown at all other game terminals 30 in the virtual room, and the camera video images of all other game terminals 30 can be shown at game terminal 30 of the supervised account. Transmission or reception of the camera video image, however, may be permitted for each account in the virtual room.

The example in which the supervised account not permitted to transmit/receive the camera video image is unable to transmit/receive the camera video image is described above. So long as the camera video image of the supervised account not permitted to transmit/receive the camera video image is not shown at other game terminals 30 and the camera video images of other accounts are not shown at game terminal 30 of the supervised account, transmission/reception per se of the camera video image may be permitted. In other words, regardless of permission by the supervisor account, the camera video image may be transmitted or received, and transmission by server Sr1 or display at game terminal 30 at a reception side may be restricted.

The example in which transmission/reception of the camera video image is approved for each chat is described above. Transmission/reception of the camera video image, however, may be approved for each friend, similarly to the chat-permitted friend. In this case, a “camera-permitted friend” may be set for each friend, and supervised account A may be permitted to transmit/receive the camera video image only to a friend registered as the camera-permitted friend, in accordance with setting made by supervisor account PA. Supervised account A may be permitted to transmit/receive the camera video image only when all in the virtual room are mutually registered as the camera-permitted friends.

Transmission/reception of the camera video image may be permitted on a period basis. For example, a chat accompanied by transmission/reception of the camera video image may be performed always with any chat-permitted friend or a predetermined chat-permitted friend, for example, for a predetermined or set period (an hourly basis, a daily basis, a weekly basis, or the like) after permission is given.

For transmission/reception of the camera video image, supervisor account PA may be able to set at least one of “always permit” and “always prohibit.” In an example where “always permit” has been set, supervised account A is permitted to transmit/receive the camera video image without newly obtaining permission by supervisor account PA in a chat. Supervised account A may freely be able to select a manner of display of the camera video image, or the manner of display may set separately by the supervisor account. In an example where “always prohibit” has been set, supervised account A may be not permitted to issue the approval request for transmission/reception of the camera video image. Alternatively, even when the approval request is issued, a pop-up does not have to be shown at the terminal of supervisor account PA. “Always permit” or “always prohibit” may be set for each friend.

Approval for the chat-permitted friend may be required for each chat. In that case, in approval for the chat-permitted friend, at least one of setting options “always permit” and “always prohibit” may be provided.

Screens for selection of the manner of display of the camera video image shown in FIGS. 16 to 18 are by way of example. For example, in the example above, upon selection of region R30 or region R31, a screen showing the manner of display at a level higher or lower by one level is shown. In another example, a bar that extends laterally is shown together with a marker corresponding to each level, and upon selection of a position corresponding to one marker by the user, the manner of display at that level may be shown on the screen. Any level may thus directly be selectable.

The example where there are first to third modes of the manner of display of the camera video image is described above. The manner of display of the camera video image, however, is not limited to the first to third modes, but another mode may be set. For example, a mode of the manner of display in which the background is made abstract may be set. Alternatively, there may be a mode in which an image of the face of the user is transmitted as being processed.

As the manner of display of the camera video image that can be set by the supervisor account, there may be a mode in which the camera video image is not shown. The mode may be the mode at the lowest level. For example, as selection from among modes ranging from a mode in which the camera video image is not shown to a mode in which the camera video image also including the background is shown is allowed, the user of the supervisor account readily understands that the user is able to set a level of a range within which the camera video image is shown. In addition, the user of the supervisor account can have such a feeling of security that the user can turn off the camera any time even when the user permits transmission/reception of the camera video image. In the example described above, while transmission and reception of the camera video image are collectively permitted, such a state can be realized that, as the supervisor account sets a mode not to show the camera video image, the supervised account can watch the camera video image of another account that is performing the chat, whereas the camera video image of the supervised account is not watched by another account. In the example where there is a mode not to show the camera video image, the mode may be set by default, or the first mode (or another mode) may be set as in the example described above.

In the example described above, the supervised account can freely make selection from among modes equal to or lower than the level of the mode of the manner of display set by the supervisor account. The supervised account, however, may be allowed to select only the mode of the manner of display set by the supervisor account. The supervisor account may be able to set a plurality of display modes from which the supervised account can make selection. The manner of display of the camera video image does not have to be defined in terms of the “level”.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A system comprising at least one memory storing instructions that, when executed, cause at least one computer of the system to execute operations comprising:
setting an approver account for a certain account;
setting the certain account and another account in friend relation without an approval by the approver account, under which a predetermined feature is available, in accordance with an application from the certain account to the another account and acceptance by the another account, of the application;
setting a second account as a communication-permitted friend for a first account for which the approver account has been set, the second account being an account among accounts set in friend relation with the first account, based on (i) an approval request from the first account for setting the second account as the communication-permitted friend for the first account and (ii) an approval for the approval request by the approver account set for the first account; and
allowing a terminal with which the first account has been associated to perform communication accompanied by sound, with a terminal with which an account that is the communication-permitted friend has been associated.

2. The system according to claim 1, wherein
the operations comprise storing information on the communication-permitted friend inputted by the approver account in a manner viewable at least by the approver account and not viewable by the first account.

3. The system according to claim 2, wherein
the information associated with the account that is the communication-permitted friend is viewable by the approver account, regardless of change of an icon image or a name of the communication-permitted friend.

4. The system according to claim 2, wherein
the operations comprise causing a terminal associated with the approver account to show another account with which the first account is currently performing communication accompanied by the sound, together with the information on the another account inputted by the approver account.

5. The system according to claim 1, wherein
the operations comprise causing, when an approval request for setting a third account as the communication-permitted friend for the first account is issued again, the third account being an account the approval request of which for setting as the communication-permitted friend for the first account was not permitted by the approver account in a past, a terminal associated with the approver account to show that the approval request of the third account was not approved in the past.

6. The system according to claim 1, wherein
the operations comprise allowing, based on (i) a camera use approval request for showing a camera video image at a terminal with which an account of a communication counterpart has been associated, the camera video image being transmitted from the first account for each communication accompanied by the sound, in which the first account participates, and (ii) an approval for the camera use approval request by the approver account set for the first account, display of the camera video image corresponding to the first account at a terminal with which another account has been associated, during communication accompanied by the sound corresponding to the approved camera use approval request.

7. The system according to claim 1, wherein
the operations comprise allowing, based on (i) a camera use approval request for showing a camera video image corresponding to another account at a terminal with which the first account has been associated, the camera video image being received by the first account for each communication accompanied by the sound, in which the first account participates, and (ii) approval for the camera use approval request by the approver account set for the first account, display of a camera video image transmitted from a terminal with which the another account has been associated at the terminal with which the first account has been associated, during communication accompanied by the sound corresponding to the approved camera use approval request.

8. The system according to claim 1, wherein
the operations comprise allowing, based on (i) an approval request for showing a camera video image between the first account and the another account for each communication accompanied by the sound, in which the first account participates, and (ii) approval by the approver account set for the first account, for an approval request for transmission/reception of the camera video image, display of the camera video image between the terminal with which the first account has been associated and a terminal with which the another account has been associated, during communication accompanied by the sound corresponding to the approved approval request.

9. The system according to claim 6, wherein
the allowing display of the camera video image corresponding to the first account at the terminal with which the another account has been associated comprises allowing the approver account to set a manner of display of the camera video image at the another terminal with which the another account has been associated, the camera video image being transmitted by the terminal with which the first account has been associated in communication accompanied by the sound, in which the terminal associated with the first account participates, the another account participating in the communication.

10. The system according to claim 9, wherein
the allowing display of the camera video image corresponding to the first account at the terminal with which the another account has been associated comprises allowing the approver account to set a plurality of levels of the manner of display of the camera video image, allowing the first account to select a manner of display of the camera video image at a level equal to or lower than a level set by the approver account, and causing the another terminal to show the camera video image in the selected manner of display.

11. A non-transitory computer-readable storage medium storing executable instructions that, when executed by at least one processor, cause at least one computer associated with a first account to execute operations, the operations comprising:
transmitting an approval request for setting a second account as a communication-permitted friend for the first account, the second account being an account among one or more accounts for which friend relation with the first account has been set, under which a predetermined feature is available; and
performing communication accompanied by sound with the communication-permitted friend via a terminal with which an account that is the communication-permitted friend has been associated.

12. A non-transitory computer-readable storage medium storing executable instructions that, when executed by at least one processor, cause at least one computer associated with an approver account for a first account to execute operations, the operations comprising:
receiving an approval request from the first account for setting a second account as a communication-permitted friend for the first account, with which the first account is configured to perform communication accompanied by sound, the second account being an account among one or more accounts for which friend relation with the first account has been set, under which a predetermined feature is available; and
transmitting approval or rejection of the approval request.

13. The non-transitory computer-readable storage medium according to claim 12, wherein
the operations comprise storing information on the communication-permitted friend inputted by the approver account in a manner viewable at least by the approver account and not viewable by the first account.

14. The non-transitory computer-readable storage medium according to claim 12, wherein
the operations comprise approving a camera use approval request for showing a camera video image at a terminal with which an account of a communication counterpart has been associated, the camera video image being transmitted from the first account for each communication accompanied by the sound, in which the first account participates.

15. The non-transitory computer-readable storage medium according to claim 12, wherein
the operations comprise approving a camera use approval request for showing a camera video image corresponding to another account at a terminal with which the first account has been associated, the camera video image being received by the first account for each communication accompanied by the sound, in which the first account participates.

16. The non-transitory computer-readable storage medium according to claim 12, wherein
the operations comprise causing the approver account to set a manner of display of the camera video image at another terminal with which another account has been associated, the camera video image being transmitted by a terminal with which the first account has been associated in communication accompanied by the sound, in which the terminal associated with the first account participates, the another account participating in the communication.

17. A method comprising:
at a terminal with which a first account has been associated,
transmitting an approval request for setting a second account as a communication-permitted friend for the first account, the second account being an account among one or more accounts for which friend relation with the first account has been set, under which a predetermined feature is available; and
performing communication accompanied by sound with the communication-permitted friend via a terminal with which an account that is the communication-permitted friend has been associated.

18. A method comprising:
at a terminal with which an approver account for a first account has been associated,
receiving an approval request from the first account for setting a second account as a communication-permitted friend for the first account, with which the first account is configured to perform communication accompanied by sound, the second account being an account among one or more accounts for which friend relation with the first account has been set, under which a predetermined feature is available; and
transmitting approval or rejection of the approval request.

19. The method according to claim 18, comprising, at the terminal with which the approver account has been associated, storing information on the communication-permitted friend inputted by the approver account in a manner viewable at least by the approver account and not viewable by the first account.

20. The method according to claim 18, comprising, at the terminal with which the approver account has been associated, approving a camera use approval request for showing a camera video image at a terminal with which an account of a communication counterpart has been associated, the camera video image being transmitted from the first account for each communication accompanied by the sound, in which the first account participates.

21. The method according to claim 18, comprising, at the terminal with which the approver account has been associated, approving a camera use approval request for showing a camera video image corresponding to another account at a terminal with which the first account has been associated, the camera video image being received by the first account for each communication accompanied by the sound, in which the first account participates.

22. The method according to claim 18, comprising, at the terminal with which the approver account has been associated, causing the approver account to set a manner of display of the camera video image at another terminal with which another account has been associated, the camera video image being transmitted by a terminal with which the first account has been associated in communication accompanied by the sound, in which the terminal associated with the first account participates, the another account participating in the communication.
